(19) United States
(12) Patent Application Publication
(10) Pub. No.: US 2008/0131323 A1
(43) Pub. Date: Jun. 5, 2008

(54) Apparatuses, Systems, and Methods Utilizing Laminar Flow Interface Control and for Controlling Laminar Flow Interface

(75) Inventors: M. Brandon Kuczenski, Pittsburgh, PA (US); William Charles Messner, Pittsburgh, PA (US)

Correspondence Address: DICKIE, MCCAMEY & CHILCOTE, P.C.;INTELLECTUAL PROPERTY DEPARTMENT, TWO P.P.G. PLACE, SUITE 400, PITTSBURGH, PA, 15222-5402, US

(73) Assignee: Carnegie Mellon University, Pittsburgh, PA (US)

(21) Appl. No.: 11/665,503

(22) PCT Filed: Oct. 13, 2005
(86) PCT No.: PCT/US05/36886

§ 371 Date: Jan. 14, 2008

Related U.S. Application Data
(60) Provisional application No. 60/618,147, filed on Oct. 13, 2004.

(51) Int. Cl. B01J 19/00; G05D 7/06; G05D 11/02

(52) U.S. Cl. 422/82.13; 422/68.1; 137/101.21; 137/118.06

(57) ABSTRACT

Apparatuses, systems, and methods for controlling the position of the interface between two or more laminar flow stream in a microfluidic device. In one embodiment, an apparatus includes a first fluid reservoir shaving an output, a first pressure sensor connected to the output of the first fluid reservoir, a first actuator connected to the first fluid reservoir, a feedback loop connected between the first pressure sensor and the first actuator, a second fluid reservoir having an output, a second pressure sensor connected to the output of the second fluid reservoir, a second actuator connected to the second fluid reservoir, a feedback loop connected between the second pressure sensor and the second actuator, and a microfluidic device including a first input connected to the output of the first fluid reservoir, a second input connected to the output of the second fluid reservoir, and an output. In another embodiment, a method includes sensing fluid pressure from a first fluid reservoir connected to a first input of the microfluidic device, adjusting a first actuator in response to the fluid pressure in the first fluid reservoir, sensing fluid pressure from a second fluid reservoir connected to a second input of the microfluidic device, and adjusting a second actuator in response to the fluid pressure in the second fluid reservoir.

### CROSS-REFERENCE TO RELATED APPLICATIONS

This application claims priority from U.S. Provisional Patent Application No. 60/618,147, filed Oct. 13, 2004, which is incorporated herein by reference.

### FIELD OF THE INVENTION

The present invention is directed to the field of fluidics and is particularly relevant to the field of microfluidics and for controlling laminar flow interfaces.

### BACKGROUND OF THE INVENTION

The complexity and small size of cells limit one's ability to study these highly intricate systems. Cells are in a constant state of feedback and response to varying environmental factors, and the classic experimental methodology of altering a single variable while holding all others unchanged can be prohibitively challenging, forcing researchers to resort to compound or highly indirect experiments, often on populations of cells. A considerable amount of processing and data interpretation is needed to interpret the results of such experiments. The accomplishments of modern biology under these constraints are stunning, but there is tremendous value in pursuing novel experimental approaches which make use of emerging technologies to consider a cell as an engineering system with easily manipulated inputs and well defined outputs.

Cells are in a constant state of feedback and response to numerous stimuli. Investigations of the dynamics of cellular response through varying electrical potential, scaffolding structure, heat, mechanical stress, and particularly to local chemical environment are important to address many biological and medical issues, such as organism development and cell differentiation, wound healing, atherosclerosis, and cancer metastasis. However, black-box approaches to probing and modeling the dynamics of cellular processes have been essentially impossible due to the absence of experimental systems to acquire quantitative input/output time series data. The dearth of technologies for quantitative high-throughput experiments is attributable to the small size and tremendous complexity of biological cells. For example, a mammalian cell may be only 30 microns in diameter and 5 microns thick but contain on the order of 10⁹ proteins, many of which act as nanomachines.

The lack of such quantitative experimental systems has hampered system biology and other biological and medical sciences. With such tools will it be possible not only to apply existing methods dynamics system and control, but to develop new theory specifically for biological systems.

The study of the dynamics of cell processes is necessary for understanding cell function, organism development, and disease. The introduction to the August 2004 special section on Biochemical Networks and Cell Regulation in IEEE Control Systems Magazine provides an excellent overview of the motivation and challenges for the study of biological processes from an engineering perspective. Increasingly, control engineers and cell biologists are collaborating as they recognize similar attributes in the systems they study such as amplification, positive and negative feedback, regulation and control, oscillatory and nonlinear behavior, bistable behavior, disturbance rejection, noise rejection, and robustness. In many instances the vocabularies of the engineering and biology domains are the same with regard to dynamic systems. However, one significant difference between the two domains is that there is generally no separate control unit in a biological regulation process. Rather, feedback control of a reaction in a biochemical pathway is performed implicitly by biological agents downstream of the reaction which manipulate the activity of other biological agents upstream of the reaction.

While control processes may be implicit, the concepts of inputs and outputs are still valid at the cellular level. The inputs can be electrical activation, scaffolding structure, heat, mechanical stress, and local chemical environment including signaling molecules. Outputs may be the release of signaling molecules, internal metabolic or catabolic changes, changes in cell structure and morphology, movement, stimulation or retardation of the cell reproductive cycle, or even apoptosis—programmed cell death.

An example of medically relevant biological process that involves signaling, control, and cell movement is wound healing, a dynamic process that results in the restoration of tissue function and integrity. The physiological process of wound healing begins at the instant of injury, and comprises the inflammatory, proliferative, and the maturation phases. In the early stages of these processes, platelet-derived and other growth factors are present and have the ability to act on many cell types including endothelial and fibroblastic cells. In the proliferative phase, fibroblasts arrive in the wound through cell migration due to chemotactic signals including the presence of growth factor. These fibroblasts then proliferate and synthesize a new extracellular matrix for the repair of tissue. During this process, fibroblast and endothelial cell populations increase, allowing them to produce their own growth factors, which further stimulate their own proliferation. Ultimately angiogenesis results through the development of granulation tissue through budding from vessels, which requires endothelial cells as part of the vasculature.

### Value of Time Series Tools

Hampering the contribution of engineers to biology has been the lack of techniques to provide chemical inputs and measure cell responses with sufficient temporal and spatial resolution to generate quantitative time series data for system identification. Biological systems and cells are fundamentally nonlinear, displaying classic hard nonlinearities such as saturation, dead zone, hysteresis, threshold trigger. Dynamic nonlinearities include bistability, limit cycles, and chaos. However, simulation of the coupled nonlinear differential equation models of certain cellular systems show nearly linear response over a relatively large range of inputs. Precise manipulation of the cellular environment and observation of the cells' response provides the intriguing opportunity to investigate the frequency response of a cell or cell population to its environment, perhaps leading to simplified input/output models of certain cellular dynamics. Even in the case of hard nonlinearities, time series data provides the opportunity to identify nonlinear dynamics and to identify the parameters of low order models without resorting to a large set of coupled nonlinear differential equations.

To observe both high-speed and protracted cell responses, the experimental apparatus must be automated. Cellular responses can be blindingly fast, on the order of 0.1 msec for calcium signaling, or excruciatingly slow, on the order of hours for cell motility or days for cell proliferation. At both extremes, human manipulation of inputs and measurement of outputs is impractical, motivating the development of automated systems for acquiring time series data.

### Microfluidics for Cell Biology Research

Cell movements occur in response to external chemical cues, including the presence of soluble chemical factors and internal chemical gradients. These responses for mammalian and non-mammalian cells include:

Actin polymerization. The extension of processes, which are driven by local actin polymerization, is the initial step in cell migration. Soluble mitogens directly activate the Rho family of GTPases (CDC42, Rac, Rho) whose downstream effectors initiate the formation of actin-based filopodia, lamellipodia, and lamella in fibroblasts.

Cell aggregation. Gradients of chemoattractants can locally affect motility in non-mammalian cells. Dictyostelium discoideum (a soil-living amoeba) preferentially move from a sparse population to a localized dense distribution when exposed to micropipette which is continuously releasing adenosine 3′,5′-cyclic monophosphate.

G-protein signaling. Experiments have implicated the G-protein signaling pathway as a possible sensation mechanism in Dictyostelium. A local chemical induction can lead to a reciprocal local activation of the pleckstrin homology (PH)-domains specific for PI(3,4,5)P3 at the membrane which also is where reorganization of the cytoskeleton and the extensions occurs. These results suggest that specific phosphoinositides direct actin polymerization to the leading-edge and thus influence cell motility. This signaling can further affect ultimate cell fate as cell motility and the PH domain of the AKT pathway also are salient in governing a variety of cellular functions.

Microfluidics techniques are ideally suited to creating and maintaining the types of external chemical gradients that generate the behavior discussed above. The ability to determine the functioning of a single cell has been handicapped by the absence of technology to introduce spatiotemporal stimulation to localized subcellular domains with single cells of sub-micron specificity. Patch clamping, micropipetting, and laser microsurgery are useful for examining local domains, but none of these methods have the potential to be as robust as those enabled by a micro- and nano-technological approach. Alternate fabrication techniques at the organic-inorganic interface can regulate the attachment and spreading of individual cells, and fluidic devices have been implemented to mediate cell population attachment as well as deliver chemical reagents to specific cell populations. Many cellular characteristics and processes have been discovered to be spatially and temporally responsive including cell structure, motility, and apoptosis.

To measure internal cell responses, methods for working at subcellular levels with control over these gradient behaviors are needed. Micro- and nano-technological approaches are ideally suited to these applications, as they can be used to design and develop systems on the size scale of cells and molecules and have been successfully interfaced with the cellular and molecular worlds in areas such as DNA transport, drug delivery targeting for cancer treatments, and electrically stimulating neural cells.

### BRIEF SUMMARY OF THE INVENTION

The present invention is applicable to the field of fluidics, and is particularly applicable to the field of microfluidics and for controlling laminar flow interfaces. Microfluidics is an area of technology with proven applications in biology research, and microfluidic devices and systems can be used to apply precisely localized time varying changes in the chemical environment of a cell and observe the cell's response. The present invention describes the design, fabrication, testing and operation of apparatuses, systems, and methods for controlling the position of the interface between two or more laminar flow stream in a microfluidic network. The present invention may be used to manipulate signals or conditions affecting a cell or other subject matter of the present invention, and to observe the response in both time and space. The present invention allows the study of the behavior of cells and other objects as “black box” systems, responding to input signals in observable ways to generate output signals which may include cell position or chemical concentration. For example, variations of a chemical or other environment of a cell can constitutes an “input”, and the cell's response to these inputs can constitute an “output”. The present invention may be used to study fundamental dynamics responses of cells, including threshold response and frequency response.

In one embodiment, an apparatus includes a first fluid reservoir having an output, a first pressure sensor connected to the output of the first fluid reservoir, a first actuator connected to the first fluid reservoir, a feedback loop connected between the first pressure sensor and the first actuator, a second fluid reservoir having an output, a second pressure sensor connected to the output of the second fluid reservoir, a second actuator connected to the second fluid reservoir, a feedback loop connected between the second pressure sensor and the second actuator, and a microfluidic device including a first input connected to the output of the first fluid reservoir, a second input connected to the output of the second fluid reservoir, and an output.

In another embodiment, a method includes sensing fluid pressure in a first fluid reservoir connected to a first input of the microfluidic device, adjusting a second actuator in response to the fluid pressure in the second fluid reservoir, sensing fluid pressure in a second fluid reservoir connected to a second input of the microfluidic device, and adjusting a first actuator in response to the fluid pressure in the first fluid reservoir.

In another embodiment, the present invention includes two or more pressure controllers providing fluid to a microfluidic device. The pressure controllers are closed-loop systems which regulate the pressure of the fluid going to the microfluidic device. In that embodiment, adjusting the inlet pressure leads to precise spatial manipulation of an interface between parallel laminar fluid flows. Relative flow rates determine the location of the interface between two adjacent streams in the output channel of the microfluidic device. There is no turbulent mixing between these streams, because the narrow channels ensure that the flows remain laminar.

Examples of investigations that may be performed using the present invention include, but are not limited to, studies of inter-cellular signaling to experiments with nutrient uptake and studies of the cell growth cycle to experiments with cell-in-the-loop control. Control over the time history of input signals and measurement of time history of outputs is fundamental to the engineering approach for modeling a dynamic system. In one embodiment of the present invention, the manipulated input will be the spatiotemporal chemical environment of a cell or populations of cells. Several outputs could be measured automatically, possibly simultaneously, of both individual cells and cell populations, including spatiotemporal intensity from fluorescence chemical probes and the position of the cell. One advantage of the present invention is the ability to flow dissimilar mixtures next to each other in a microfluidic channel without turbulent mixing of the constituent chemicals.

The microfluidic device may be prepared by placing a polydimethylsiloxane (PDMS) slab with channel features molded into its surface on a glass coverslide. In one embodiment, the channels are 100 μm wide and 50 μm deep in cross-section, generating flow with a characteristic Reynolds number on the order of 1, thus ensuring laminar flow, limiting the mixing of constituent chemicals to diffusion.

In one embodiment, the present invention may be controlled by one or more computers or processors, such as a supervisory computer program to execute closed loop control over fluid pressure. Alternatively, the present invention may be controlled by a human, or by a combination of human and computer control.

In another embodiment of the present invention, the pressure controllers take commands from a supervisory computer program to regulate the flows through the microfluidic device. Fluorescent markers and an automated computer vision system provide quantitative interpretation of a cell's response to these input signals and measurement of chemical interfaces for precise position control of the chemical gradient between to adjacent laminar flow streams. The results of real-time processing of observed signals can be stored for analysis or interpreted as feedback signals for high-level control loop that sends further commands to the system. The system will allow observation of the response of cells without destroying the cells through the observation process.

Another embodiment of the present invention includes an optical microscope with fluorescence imaging camera to observe the interface and the cells in the outflow channel. A computer vision system will enable detection of the interface position, of a cell's position and morphology, and of fluorescent chemical probes. The present invention can provide not only time series data for black-box or grey-box modeling, but also the feedback signals for automatic control with a cell or cells in the loop.

In another embodiment, a human operator looking through a microscope can reproducibly manipulate the flow interface by manipulating controls, such as buttons or knobs of the user interface, and perform a wide variety of investigations into cells' dynamic behaviors.

Many variations are possible with the present invention. For example, the present invention is capable of being embodied in many different forms, such as embodiments having channels with dimensions other than those specifically recited herein, embodiments having more than two input channels, embodiments having more than one output channel, embodiments having different flow rates, and other variations. These and other teachings, variations, and advantages of the present invention will become apparent from the following detailed description of the invention.

### BRIEF DESCRIPTION OF THE SEVERAL VIEWS OF THE DRAWING

Embodiments of the present invention will now be described, by way of example only, with reference to the accompanying drawings for the purpose of illustrating the embodiments, and not for purposes of limiting the invention, wherein:

FIG. 1 is a schematic illustrating one embodiment of a fluid control apparatus according to the present invention;

FIGS. 2-13 illustrate embodiments of microfluidic devices according to the present invention;

FIG. 14 is a graph illustrating fluidic interface position versus normalized pressure difference in one embodiment of the present invention;

FIGS. 15-17 are schematics illustrating embodiments of fluid control apparatuses according to the present invention;

FIG. 18 illustrates pathways of images captured in the present invention, wherein a combination of individually simple filters will process images to aid in data extraction;

FIG. 19 is a schematic illustrating one embodiment of a fluid control apparatuses according to the present invention;

FIG. 20 is a graph illustrating the output of the pressure sensor from one embodiment of the present invention;

FIG. 21 is an image of a fluid interface between aqueous cascade blue (upper channel) and water (lower channel) at 1 kPa pressure difference;

FIG. 22 is an image of a fluid interface between aqueous cascade blue (upper channel) and water (lower channel) at 2 kPa pressure difference;

FIG. 23 is a graph illustrating florescence intensity at ten microns (solid line) and 250 microns (dashed line) along the length of the main channel illustrated in FIG. 21;

FIG. 24 is a graph illustrating florescence intensity at ten microns (solid line) and 250 microns (dashed line) along the length of the main channel illustrated in FIG. 22;

FIGS. 25-26 are schematics showing sinusoidal stimulation of a subcellular domain;

FIG. 27 is a schematic representation of a two compartment model for intracellular transport of a chemical species; and

FIGS. 28 and 29 illustrate additional embodiments of the present invention.

### DETAILED DESCRIPTION OF THE INVENTION

The present invention is generally applicable to the field of fluidics, and is particularly relevant to the field of microfluidics and the control of a laminar flow interface. The present invention will generally be described in terms of controlling the chemical environment of a cell. However, the present invention is relevant to a much wider range of technologies and applications, such as the manufacture and operation of microdevices or Microsystems such as micro-electromechanical systems, semiconductor fabrication, molecular self-assembly, and other technologies and applications.

In one embodiment, the present invention can be used for actively controlling cells' chemical environments with subcellular precision and time-domain variability. For example, the present invention can be used to aid the transmission of time varying chemical signals to cells. Because the fluid flow is incompressible at certain pressures, including those used in these applications, flow rate through a channel with a given geometry and viscosity is a function of only the forcing pressure, as given by a form of the Darcy-Weisbach Equation (Equation 1) for laminar fluid flow in a closed channel:

$$\begin{matrix}\frac{Δ p}{1 / 2 ρ {V}^{2}} = \frac{C}{{Re}_{h}} \frac{L}{{D}_{h}} & ( 1 ) \\ Q = V A = \frac{2 {D}_{h}^{2}}{Cl μ} A Δ p = K Δ p & ( 2 )\end{matrix}$$

where the symbols used have the following meanings:

A Channel cross-sectional area

Reₕ Reynolds Number, ρV Dₕ/μ

C Friction Factor geometric constant

Dₕ Hydrostatic Diameter, 4A/P

K Proportionality constant, defined in Equation 2

L Fluid channel length

P Wetted perimeter of channel

p Hydrostatic Pressure

ρ Fluid Density

Q Volumetric Flow Rate

V Average fluid velocity

μ Kinetic viscosity

When two fluid streams come together at a fluid channel junction, the difference of the volumetric flow rates through the two inlet channels can be shown to be proportional to the difference in pressure between the two inlet reservoirs, assuming a symmetrical Y-shaped fluid network:

Q₂−Q₁=K(p₂−p₁) (3)

Because the two adjacent flows must be isobaric in the output channel, a difference in flow rates translates to a shift of the fluid interface between the flows. Under laminar conditions, flow will not cross fluid “stream lines,” and thus adjacent flows will not mix except by diffusion. Hence, by regulating the pressures of two or more independent semistatic fluid reservoirs feeding two or more inlet channels to a microfluidic network, the operator can adjust the transverse position of the fluid interface in the outlet channel.

One advantage of the present invention is the ability to flow dissimilar mixtures next to each other in a microfluidic channel without turbulent mixing of the constituent chemicals. Placement of a cell within the laminar flow stream allows local stimulation of subcellular domains by the rapid influx of molecules over one region of a cell and rapid efflux at another. Using fluorescent markers, one can observe the fluid interface in a microscope. By doping one channel with at least one chemical stimulant or signal of interest, the present invention may be used to manipulate the environments of individual cells. Other markers can also be used to obtain other information, such as quantitative signification of cellular responses.

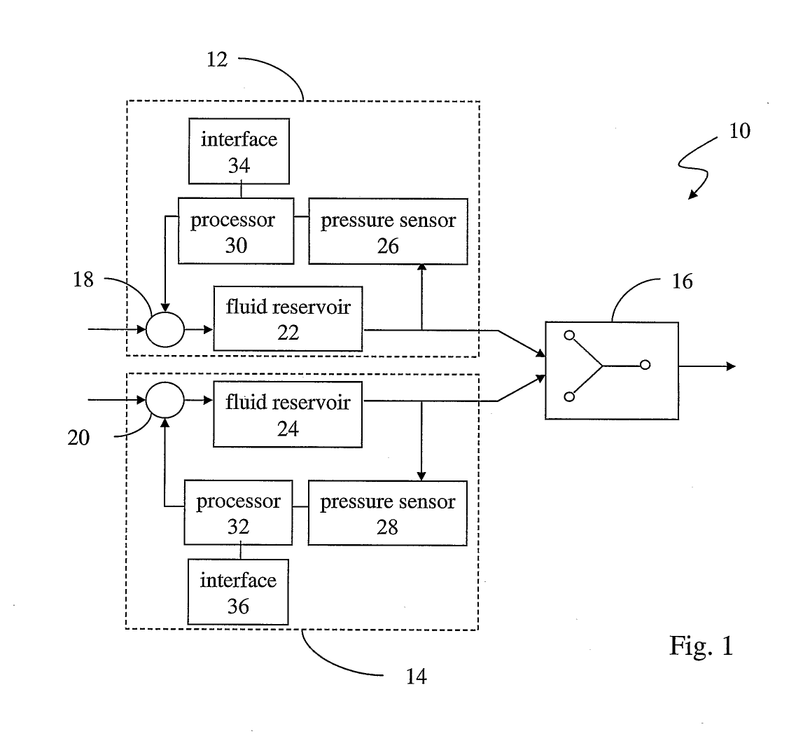

FIG. 1 is a schematic illustrating one embodiment of a fluid control apparatus 10 according to the present invention. The apparatus 10 includes first 12 and second 14 pressure controllers and a microfluidic device 16. Although the present invention will generally be described in terms of two pressure controllers 12, 14 and a Y-shaped microfluidic device 16, other variations are possible. For example, the present invention may use more than two pressure controllers and a microfluidic device with more than two inputs and more than one output. Alternatively, a single pressure controller may be used to control two or more actuators and fluid reservoirs. The present invention may also use more than one microfluidic device, connected in series and/or in parallel.

The pressure controllers 12, 14 introduce their fluids at a controlled pressure into the microfluidic device 16. The pressure controllers 12, 14 may include, for example, actuators 18, 20 such as electric motors or solenoids, and may act on a fluid reservoir 22, 24, such as a syringe. For example, the pressure controller 12, 14 may include an electric motor 18, 20 actuating a straight plunger connected to a moveable member of the fluid reservoir 22, 24. In another example, the motor 18, 20 may turn a screw mechanism connected to a moveable member to control pressure in the fluid reservoir 22, 24. In another example, the motor 18, 20 may deform the walls of the fluid reservoir 22, 24, such as one may force toothpaste out of a tube by squeezing the tube. Other embodiments are also possible. The pressure controllers 12, 14 may be closed loop devices including, for example, pressure sensors 26, 28 to provide feedback to an electric motor or other actuator 18, 20 in order to adjust the fluid pressure. Computers or processors 30, 32 may be used to process the feedback signal and control the actuators 18, 20. To make the pressure controllers 12, 14 simple to use, they may include an interface 34, 36, such as a menu-driven user interface or other interface for the user.

The pressure sensors 26, 28 sense the output of the fluid reservoirs 22, 24. The output of the fluid reservoirs 22, 24 may be sensed by measuring pressure directly from the fluid reservoirs 22, 24, or it may be done by measuring the pressure downstream from the fluid reservoirs 22, 24. The data from the pressure sensors 26, 28 may or may not need to be compensated, depending on the accuracy required, depending on where the sensing is performed, and depending on other factors such as the compressibility of the fluid.

By utilizing a closed-loop system that regulates pressure instead of flow, one can achieve high precision even at very low flow rates of one or both streams. In one embodiment, the present invention uses a Direct Current (DC) motor to actuate a syringe plunger. Because the microfluidic systems used in the embodiments described herein have low rates of fluid flow, the syringe plunger will be virtually nonmoving in the syringe, and the motor will be effectively stalled. Therefore, a voltage control signal into the motor is equivalent to a current control signal through the motor's coils. Thus, since shaft torque is immediately proportional to coil current, the stalled motor can be thought of as a force actuator instead of a position actuator, ideal for control of fluid pressure. In one embodiment the motor is driven by pulse-width modulation with a 39-kHz pulse frequency and 10-bit output resolution.

In general, the responsiveness of the pressure controller 12, 14 is dictated by two characteristics: its mechanical stiffness and the speed of its control loop. The device's precision is governed by the resolution of its sensor input. Accordingly, in one embodiment the pressure controller includes a 1-kHz servo frequency, a stiff mechanical design, and a 125 Pa sensor reading quantization.

In one embodiment the pressure controller 12, 14 includes an embedded digital PIC microprocessor manufactured by Microchip, Inc, which utilizes a 10-bit internal PWM output for motor control, a 10-bit internal A/D converter for sensor feedback, and either a PIED compensator or an arbitrary second-order filter operating at 1-kHz closed-loop servo frequency. This high servo frequency enables servo loop operation at frequencies as high as 50 Hz, far in excess of the mechanical bandwidth typical for such a system. In one embodiment, a processor 30, 32 may be included in each pressure controller 12, 14. The processors 30, 32 may be in the feedback loops between the pressure sensors 26, 28 and the actuators 18, 20, receiving signals indicative the fluid pressure and providing control signals to the actuators 18, 20. Alternatively, a single processor may be used for two or more pressure controllers 12, 14, such as by being connected to the two or more pressure sensors 26, 28 and providing control signals to the two or more actuators 18, 20.

In one embodiment, users can directly interact with the processors 30, 32 in the pressure controllers. This interaction may be, for example, through a stand-alone user interface 34, 36. One embodiment of a stand-alone interface 34, 36 includes a liquid crystal display, buttons, and a rotary knob which allow the users to interact via a menu-driven interface 34, 36, similar to the interfaces often used in cellular phones. As an alternative to the stand-alone interface 34, 36, users may interact with the present invention via a separate processor, such as is described in more detail hereinbelow. For example, a software interface running on a computer and connected to the pressure controllers via a communications link, such as EIA/TIA-232 serial communication, may be used. In one embodiment, a software interface is written in MATLAB, thereby allowing ready access to visualization and analysis tools.

Precision and responsiveness are two important characteristics of the pressure controllers 12, 14. In certain applications, a difference in pressure on the order of 7-14 kPa (1-2 PSI) is sufficient to sweep the fluid interface across the range of interest in a 100-micron-wide channel. In one embodiment, the pressure controllers 12, 14 include 15-psi monolithic pressure sensors 26, 28 from Honeywell. That sensor has a 4-volt output range which, when digitized by a 10-bit A/D converter, provides sensor resolution of 125 Pa (0.018 PSI) per least significant bit of input.

The microfluidic device 16 may be Y-shaped with two input channels connected to the pressure controllers and one output channel. The fluids from the pressure controllers are brought together in the microfluidic device and the laminar flow interface between the fluids can be controlled according to the present invention.

The microfluidic device 16 and channels to and from the microfluidic device 16 may be molded into the surface of a slab of poly-(dimethylsiloxane), or PDMS, bonded to a glass coverslide. In one embodiment, the channels are 100 μm wide and 50 μm deep in cross-section, generating flow with a characteristic Reynolds number on the order of 1, thus ensuring laminar flow.

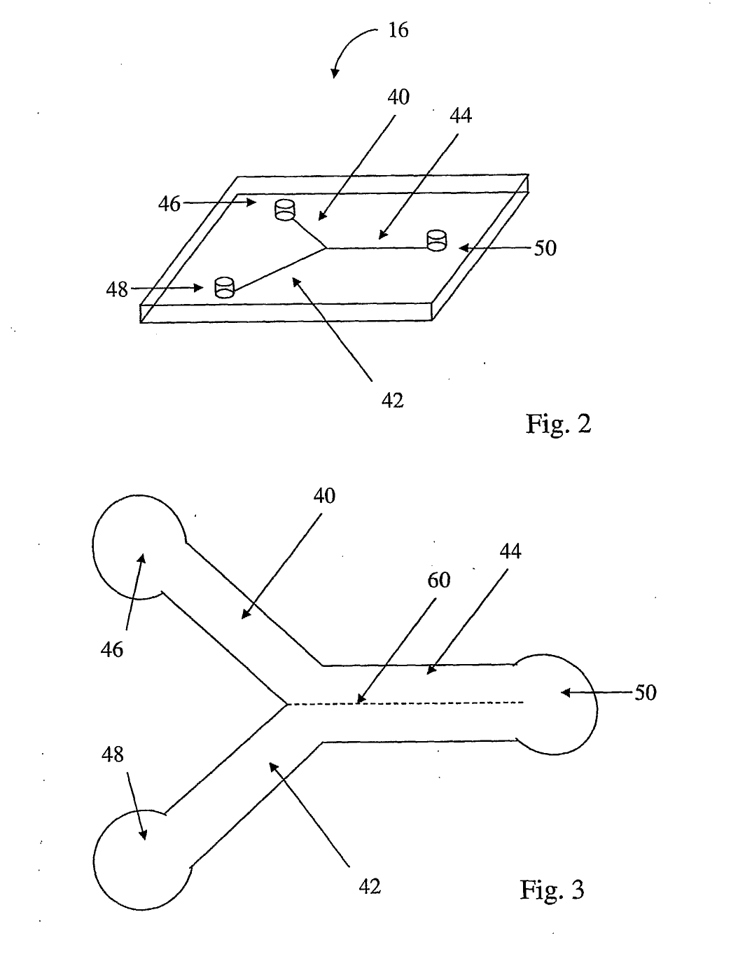

FIG. 2 illustrates one embodiment of a microfluidic device 16. The device 16 includes two input channels 40, 42 and an output channel 44. Each channel includes a well or opening 46, 48, 50 through which fluid may be provided into the microfluidic device, or through which fluid may leave the microfluidic device.

FIG. 3 is a schematic drawing illustrating a cross-sectional view of a microfluidic device 16. Each input channel 40, 42 is carrying a fluid, and the interface 60 between the two fluid streams is illustrated with a dashed line. The interface 60 is illustrated as being approximately centered in the output channel 44, although this is not necessarily the case. The input 40, 42 and output 44 channels are all illustrated as being approximately the same diameter, although this is not required. For example, some channels may be larger than others.

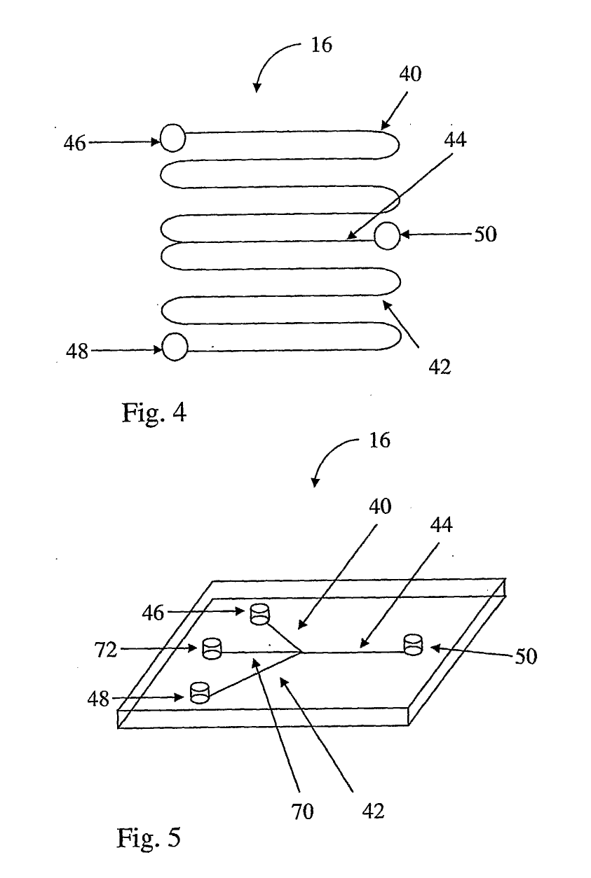

FIG. 4 illustrates another embodiment of a microfluidic device 16. In that embodiment, the input channels 40, 42 are much longer than in the previous embodiment, and the input channels 40, 42 are also longer relative to the output channel 44. In general, longer channels 40, 42, 44 will increase the resistance to fluid flow. Furthermore, the ratio of inlet lengths 40, 42 to outlet length 44 will affect the amount of fluid pressure required to cause a given change in the fluid interface. Accordingly, the illustrated embodiment, with a relatively high ratio of inlet lengths 40, 42 to outlet length 44, will require a greater difference in input pressure to effect the same change in the flow interface. As a result, the illustrated embodiment will allow for more precise adjustments to the flow interface.

FIG. 5 illustrates another embodiment of a microfluidic device 16. In that embodiment, three input channels 40, 42, 70 and three input wells 46, 48, 72 are provided, resulting in two fluid interfaces (not shown), which can be individually controlled. In this embodiment, a different input fluid may be used with each input channel 40, 42, 72. Alternatively, the same fluid may be used in more than one input channel 40, 42, 72.

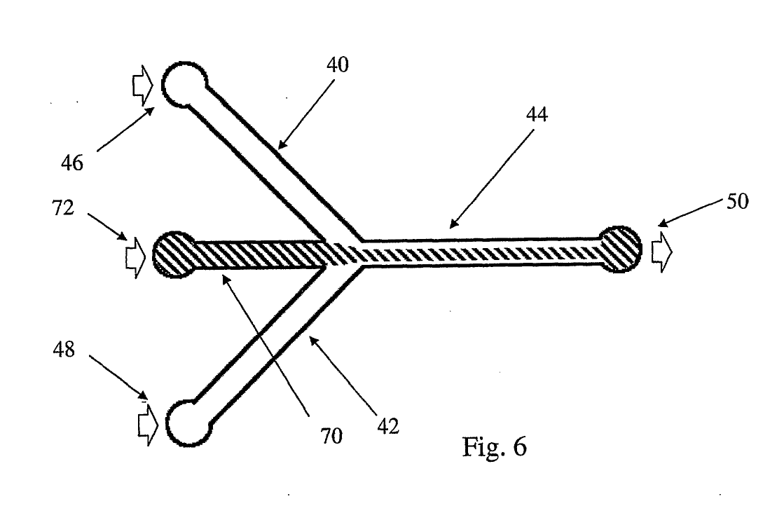

FIG. 6 is a schematic drawing illustrating a cross-sectional view of the microfluidic device 16 of FIG. 5. In that embodiment, three input channels 40, 42, 70 provide three input fluids, resulting in two fluid interfaces between the three fluid streams.

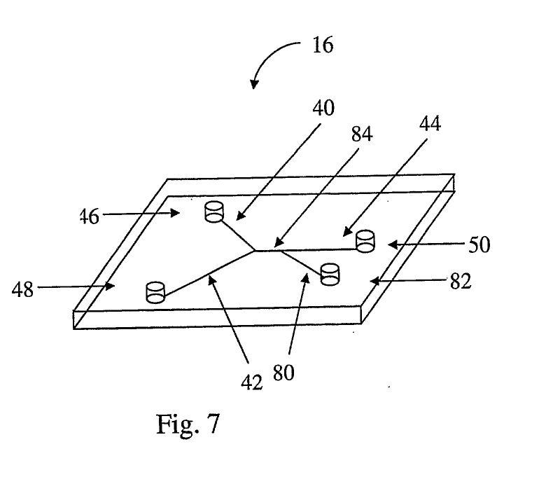

FIG. 7 illustrates another embodiment of a microfluidic device 16 having two input channels 40, 42, two output channels 44, 80, and two output wells 50, 82. In addition, there is a common channel 84 between the confluence point where the input channels 40, 42 merge and the point where the output channels 44, 80 separate.

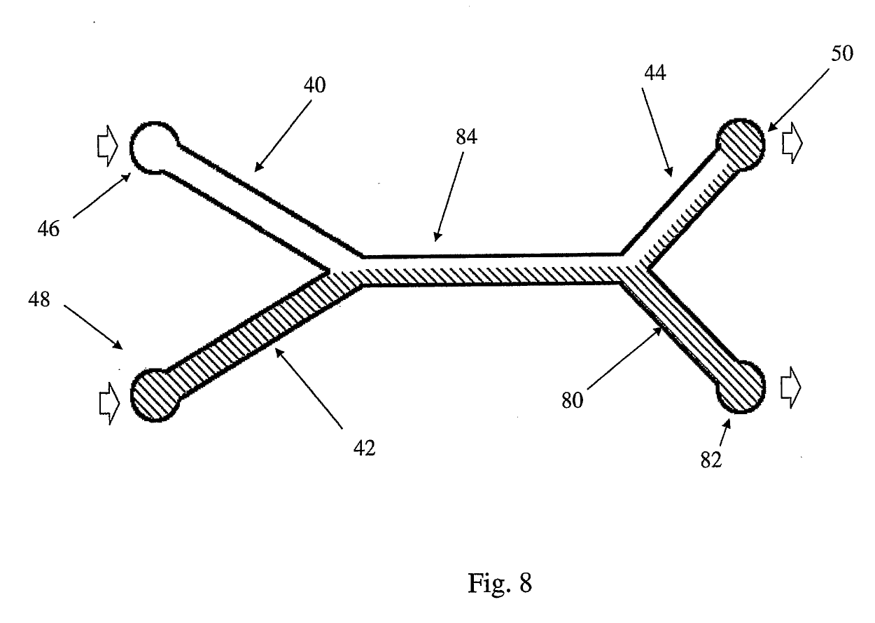

FIG. 8 is a schematic drawing illustrating a cross-sectional view of an embodiment of a microfluidic device 16 similar to that of FIG. 7. In FIG. 8 the fluid interface is biased so that some of the fluid from both input channels 40, 42 exits through one of the output channels 44, while fluid from only one input channel 42 exits through the other output channel 80. In other embodiments, the fluid interface may be biased so that all or nearly all of the different fluids exit through different output channels 44, 80.

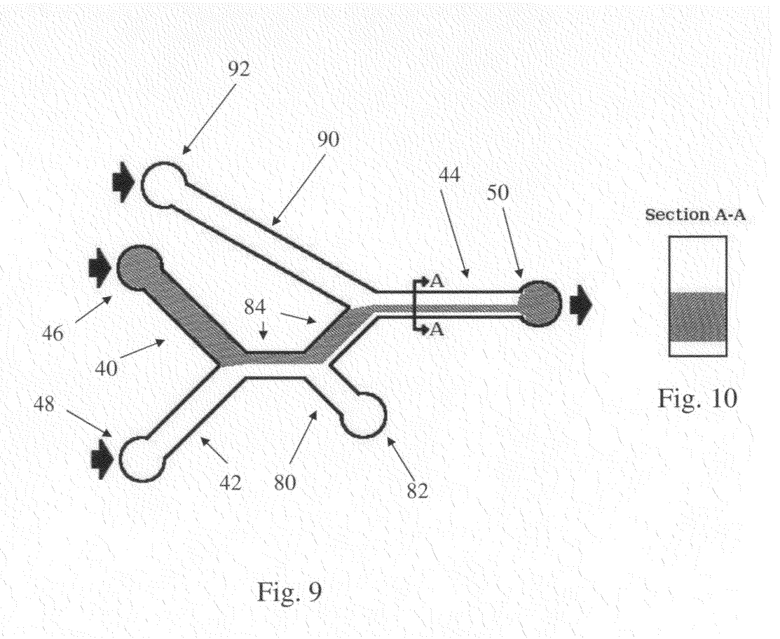

FIG. 9 is a schematic drawing illustrating a cross-sectional view of another embodiment of a microfluidic device 16. In that embodiment, there is a third input channel 90 and third input well 92. The input channels 40, 42, 90 do not all come together at the same point, and the output channels 44, 80 do not separate at the same point. This may be accomplished, for example, by fabricating a single, more complex microfluidics device 16, or by connecting several microfluidic devices 16 together.

The illustrated embodiment offers certain advantages, including the ability to smoothly remove and reintroduce one or more of the fluid streams from output channel 44. This is because the additional output channel 80 allows the flow from input channel 42 to continue through the microfluidic device 16, even if the fluid from input channel 42 is not passing through output channel 44. If a microfluidic device 16 were to turn a fluid stream off and on with only one output channel, the fluid stream turned off would stop flowing into the microfluid device 16 and, over time, a back flow of fluid would occur in that turned-off fluid stream. However, in the illustrated embodiment the extra output channel 80 allows pressure and flow to be maintained for the fluid in input channel 42, thereby avoiding the backflow problem. When the fluid from input channel 42 is not desired in output channel 44, the fluid pressure from input channel 42 is reduced (or the fluid pressure in one or more other input channels 40, 90 is increased) so that the fluid from input channel 42 is carried out of the microfluidic device entirely by output channel 80, while still providing adequate flow and pressure to maintain laminar flow of the fluid and to avoid back flow. As a result, when it is desired to reintroduce the fluid into output channel 44, it can be done smoothly.

In order to allow for a margin of error, some of the fluid from input channel 40 is also exited through output channel 80. In another variation, the fluids from both input channels 40 and 42 may exit through output channel 80, providing only the fluid from input channel 90 in the output channel 44.

FIG. 10 illustrates a cross-sectional view along line A-A of FIG. 9. From this figure it can be more easily seen that output channel 44 include three fluid streams forming two fluid interfaces.

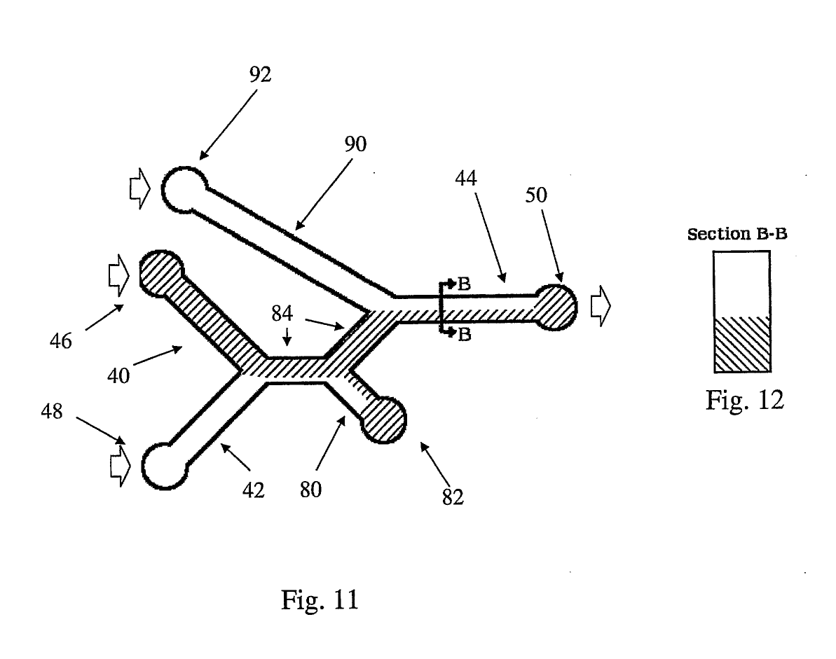

FIG. 11 is a schematic drawing illustrating a cross-sectional view of the microfluidic device 16 of FIG. 9 being operated in a different condition. In particular, in FIG. 11 the fluid stream from input channel 42 is no longer flowing in output channel 44. Instead, the fluid stream from input channel 42 is exiting entirely through output channel 80.

FIG. 12 illustrates a cross-sectional view along line B-B of FIG. 11. From this figure it can be more easily seen that output channel 44 include only two fluid streams because the fluid from input channel 42 is entirely diverted to output channel 80.

Various factors may be considered when choosing a particular embodiment of the microfluidic device 16 including, but not limited to:
i. Fast response of the interface movement to changes in inlet pressure including transport delays.
ii. Low flow rates to conserve expensive chemicals, maintain laminar flow, and keep shear forces from dislodging cells anchored to the channel floor.
iii. Capability to use of the full dynamic range of the inlet pressure control without back flow.
iv. Sufficient width and depth to flow cells into the channels and anchor them.
v. Simple structure for ease of fabrication with the PDMS molding process.

The design parameters are the absolute and relative lengths of the inlet and outflow channels, the cross sectional dimensions of the channels, and the layout of the channel on the PDMS (e.g. serpentine). For example, channels 100 microns wide and 50 microns deep are needed to flow mammalian endothelial cells into the channels and to prevent them from significantly disrupting the flow profile. Complicated structures for providing large pressure drops over short distances to reduce flow rates may be difficult to fabricate. If higher pressure resolution is needed, a more sensitive pressure sensor could be used. Alternately, if higher flow rates (and consequently higher pressures) are desired, a sensor capable of withstanding higher pressures could be chosen.

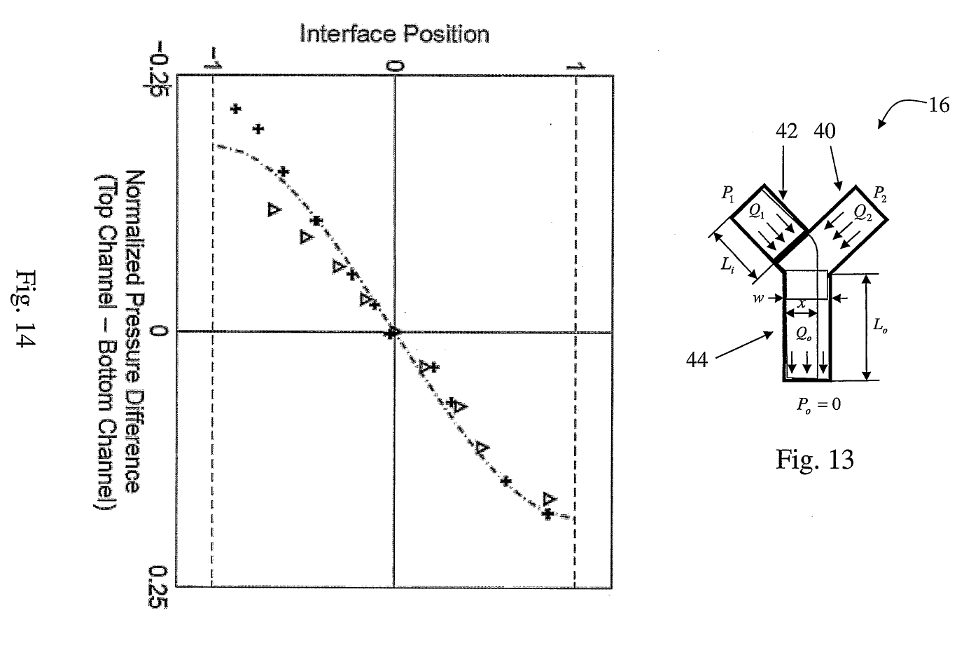

Considering only the absolute and relative lengths of the channels is illustrative of the design trade-offs. The four options are (a) short inlet and outflow, (b) long inlet and outflow, (c) short inlet and long outflow, and (d) long inlet and short outflow. Aim (i) precludes option (a). FIG. 13 and the associated equations represent a model of the steady state flows in the microfluidic device 16. The assumptions are that the channels 40, 42, 44 have the same cross section, flow rate is proportional to the pressure drop, the fluid is incompressible, the velocity profile is constant across a channel (i.e., shear effects are ignored), and momentum effects, are negligible.

The fundamental relations are below with the variables defined in FIG. 13.

$$\begin{matrix}Continuity relations & {Q}_{o} = {Q}_{1} + {Q}_{2} & {Q}_{1} = \frac{x}{w} {Q}_{o} & {Q}_{1} = \frac{w - x}{w} {Q}_{o}\end{matrix} \qquad ( 4 )$$

Pressure/flow relations αLᵢQ₁=P₁−P_{c} αLᵢQ₂=P₂−P_{c} αLₒQₒ=P_{c} (5)

wherein:

w width of channels

x position of interface

Lᵢ length of inlet channels

Lₒ length of outflow channels

P₁ pressure at inlet 1

P₂ pressure at inlet 2

P_{c} pressure at confluence point

Q₁ flow rate in inlet channel 1

Q₂ flow rate in inlet channel 2

Qₒ flow rate in outflow channel

α flow impedance parameter

The inputs are the pressures, and the unknowns are the flow rates, the pressure at the confluence point, and the location of the interface. There are six equations, but only five of them are independent; adding the second and third continuity equation yields the first one. Solving for the unknowns gives

$$\begin{matrix}Flow rates {Q}_{o} = \frac{{P}_{1} + {P}_{2}}{α ( 2 {L}_{o} + {L}_{i} )} {Q}_{1} = \frac{( \frac{{L}_{o}}{{L}_{i}} + 1 ) {P}_{1} - \frac{{L}_{o}}{{L}_{i}} {P}_{2}}{α ( 2 {L}_{o} + {L}_{i} )} \\ \begin{matrix}{Q}_{2} = & \frac{( \frac{{L}_{o}}{{L}_{i}} + 1 ) {P}_{2} - \frac{{L}_{o}}{{L}_{i}} {P}_{1}}{α ( 2 {L}_{o} + {L}_{i} )}\end{matrix} & ( 6 ) \\ Interface location x = \frac{( \frac{{L}_{o}}{{L}_{i}} + 1 ) {P}_{2} - \frac{{L}_{o}}{{L}_{i}} {P}_{1}}{{P}_{1} + {P}_{2}} w \\ Pressure at confluence {P}_{c} = \frac{{L}_{o}}{2 {L}_{o} + {L}_{i}} ( {P}_{1} + {P}_{2} ) & ( 7 )\end{matrix}$$

In contrast, if it is assumed that the velocity profile across the channel is parabolic along any cross-section parallel to the plane of the channel, then the interface position can be similarly determined. Such calculations will usually be more accurate. In either case, the interface position is a function of the forcing or inlet pressures, indicating that the only transport delay between adjusting the forcing or inlet pressures and shifting the interface position at the point of confluence is due to compliance in the fluid or the channels.

As expected, “long” channels are needed for low flow rates at reasonable pressures. The pressure at the confluence of the three channels must be less than either of the pressures at the input channels to avoid backflow into one of the inlets channels 40, 42. This requirement leads to the relations:

$$\frac{{L}_{o} + {L}_{i}}{{L}_{o}} {P}_{2} > {P}_{1} > \frac{{L}_{o}}{{L}_{o} + {L}_{i}} {P}_{2} \qquad ( 8 )$$

The ratio (Lₒ+Lᵢ)/Lₒ should be large, and Lₒ/(Lₒ+Lᵢ) should be small to employ the full dynamic range of the pressure control without backflow. Thus, the inlet channels 40, 42 should be long relative to the outflow channel 44.

An extension of this analysis leads to the conclusion that transport delay down the length of the outlet channel varies inversely with the size of the pressure change. The reason is that higher pressure leads to faster flow, so that a change in the interface location at the confluence point propagates down the outflow channel 44 more quickly than a change in the interface due to a lower pressure. The magnitude of these effects will vary depending on the particular application, and system identification and feedback control may be used to account for them. Despite the transport delay in the outlet channel 44, the is little or no transport delay at the point of confluence.

FIG. 14 is a graph illustrating interface position versus normalized pressure difference in one embodiment of a microfluidic device 16 having two input channels 40, 42 and one output channel 44 in which the input channels 40, 42 and output channel 44 are approximately the same length and the data has been normalized to the dashed line. The “+” data points represent an apparatus in which a first pressure controller 12 is operating at 4 psi, and a second pressure controller 14 is varying about 4 psi. The triangle data points represent an apparatus in which a first pressure controller 12 is operating at 3 psi and a second pressure controller 14 is varying about 3 psi. That graph illustrates that there is linear behavior for small pressure differences between the input channels 40, 42.

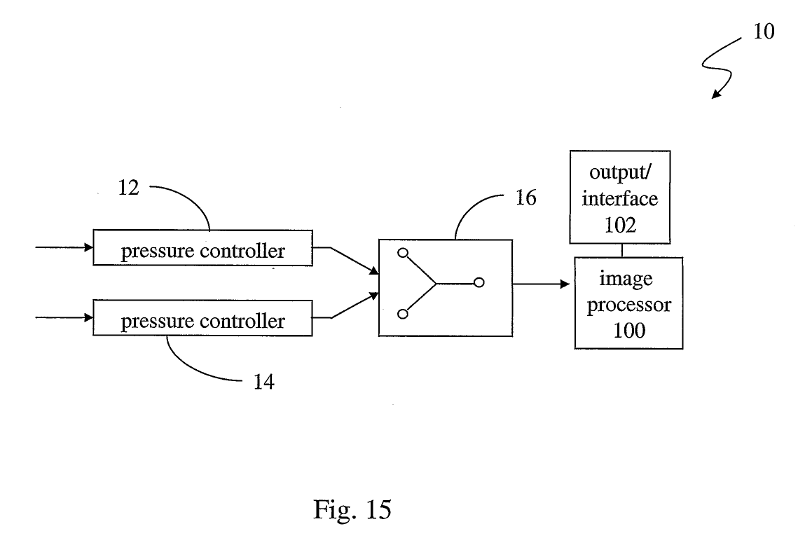

FIG. 15 is a schematic illustrating another embodiment of a fluid control apparatus 10 according to the present invention. In that embodiment, subject matter in the microfluidic device 16, such as a cell or other object, is processed for enhanced imaging by an image processor 100. The processing may be done, for example, with florescence and image processing equipment. The image processor 100 may include an interface 102, such as to allow a user to control the image processor and to provide output for a user to observe the subject matter of the microfluidic device, or the image processor 100 may receive control signals or provide output for use in controlling the process within the microfluidic device 16, or the image processor may be used for other purposes.

Image processing generally includes collecting, analyzing and reducing the data. Put simply, the task includes, for example, the careful inspection of microscopic images and the isolation of “features of interest” from visual data. The abundance of fluorescent indicators available, and the fact that the microscope has historically been the observational tool of choice in biology, suggest that visual data is an ideal medium in which to work, although it is possible to employ more conventional forms of data collection using sensors, including electrochemical sensors and electrophysiological sensors.

For example, fluorescent dyes can be attached to specific proteins. When the fluorescent dyes are excited at one wavelength, they produce an emission at another wavelength. As a result, the subject that is tagged with the fluorescent dye can be imaged more easily and/or more precisely. The location of the emission indicates the location of the item tagged, and the intensity of the emission indicates its concentration.

More than one fluorescent dye, producing emissions at different wavelengths, may be used. For example, biologically inert Cascade Blue Dextran, available from Invitrogen Corporation as part number D-1976 in their “Molecular Probes” line of products, may be used as a positional marker to mark the boundary between upper and lower channel flows, while a green fluorescent protein that targets specific proteins of interest may be used as a biological marker indicating cellular behavior.

When fluorescent dyes may also be used to identify the subject in the microfluidic device, image processing equipment 100 may be used to quickly search for the particular emission wavelength corresponding to the subject, and disregard the image data that is not within a predetermined distance from the subject. By doing this, it is possible to quickly identify the area of interest within the microfluidic device, thereby reducing the amount of subsequent image processing that is required. As a result, advantages such as real time image processing may be possible when they would otherwise be unavailable or impractical.

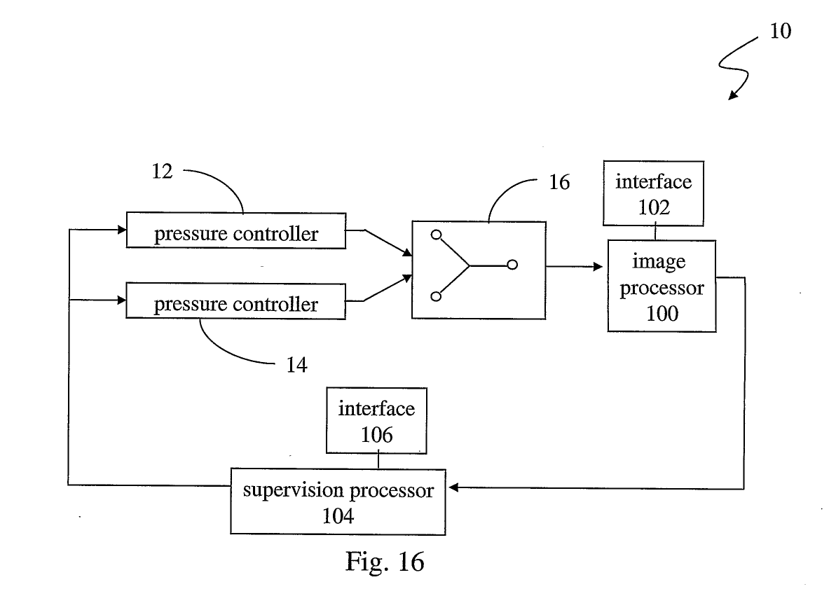

FIG. 16 is a schematic illustrating another embodiment of a fluid control apparatus 10 according to the present invention. In that embodiment, a supervision processor 104 receives information from the image processor 100, and provides information, such as control signals, to the pressure controllers 12, 14. The supervision processor 104 may also include an interface 106. In another embodiment, the supervision processor 104 may be replaced with human supervision. For example, a human may receive the information from the interface 102 of the image processing equipment 100 and make desired adjustments, such as through the interface 102 in the image processor 100, through interfaces 34, 36 (see FIG. 1) in the pressure controllers 12, 14, through the interface 106 with the supervision processor 104, or through other means. In another embodiment, both human supervision and computer supervision may be used. For example, a human may monitor the activities of the supervision processor 104, or the supervision processor 104 may enforce rules or limitations on the process being controlled by the human.

For example, the image processing may track the location of the fluid interface, and provide that information to the supervision processor 104. The supervision processor 104 can process that information and provide appropriate control signals to the pressure controllers 12, 14 to adjust or maintain the fluid interface in the desired position.

In another example, the image processor 100 may track a characteristic of a cell within the microfluidic device 16, and provide that information to the supervision processor 104. The supervision processor 104 can provide control signals to the pressure controllers 12, 14 to provide the desired effects on the cell.

The supervision processor 104 may provide control signals directly to the actuators 18, 20 (see FIG. 1) in the pressure controllers 12, 14. Alternatively, the supervision processor 104 may indirectly control the actuators by providing control signals to one or more processors 30, 32 (see FIG. 1) within the pressure controllers 12, 14, and the processors within the pressure controllers 12, 14 may directly control the actuators based, in part, on the control signals from the supervision processor 104. In another embodiment, the processors within the pressure controllers 12, 14 may provide control signals to the supervision processor 104, and the supervision processor 104 may directly control the actuators based, in part, on the signals from the processors in the pressure controllers 12, 14. Other variations are also possible, such as the supervision processor 12, 14 and the processors within the pressure controllers 12, 14 providing control signals to one or more other processors (not shown) which directly control the actuators, such as processors located at or within the actuators.

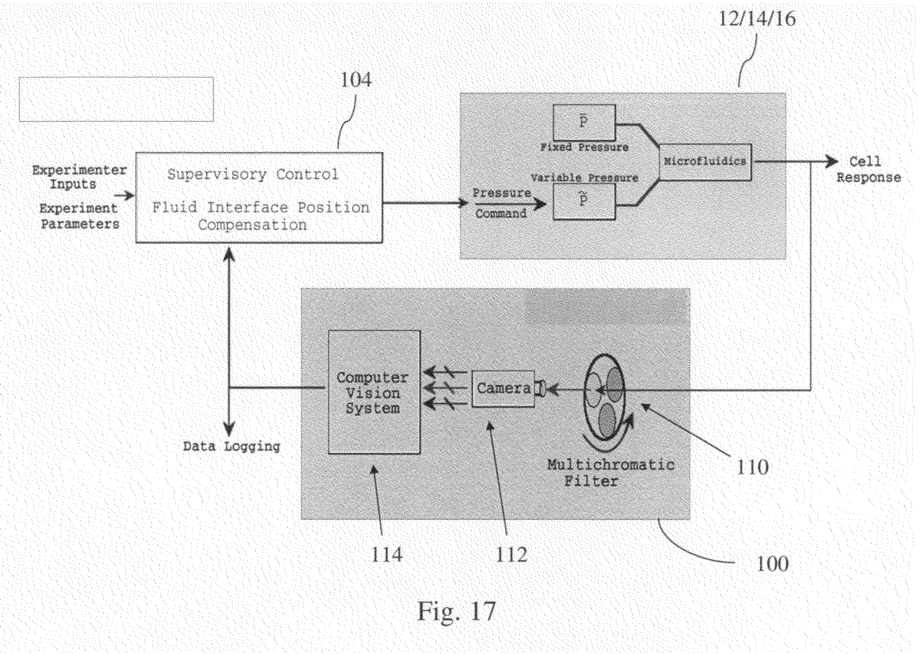

FIG. 17 is a schematic illustrating another embodiment of a fluid control apparatus 10 according to the present invention in which the image processor 100 may include, for example, one or more filters 110, a camera 112, and a computer vision system 114.

Wavelength-dependent filters 110 may be used with fluorescent probes for data extraction for isolating these data from each other. A multichromatic filter 110 placed in the path of the excitation light will determine the emission spectrum before reaching the observational equipment 112, 114. The filter 110 will alternate the excitation wavelength to stimulate different dyes to fluoresce. The digital camera 112 will capture interleaved images, alternating between all the signals of interest in the experiment and resulting in multiple channels of single-color, grayscale data, each of which lends itself to convenient and natural algorithmic manipulation.

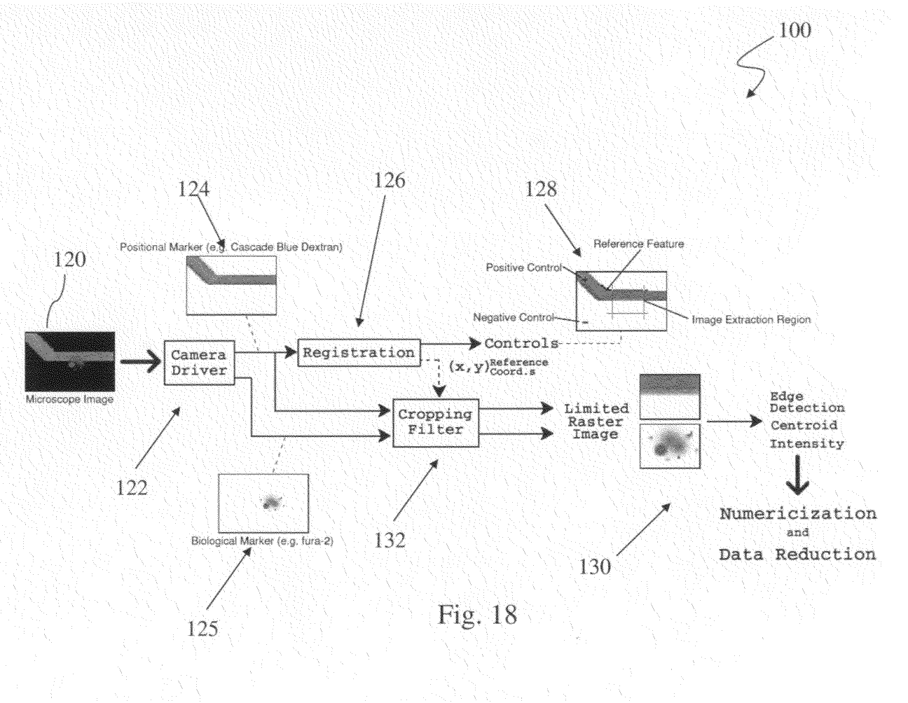

FIG. 18 illustrates one embodiment of the image processor 110 according to the present invention which shows a pathway these images might traverse through hardware and software in the image processor 100. An image 120 of the channel containing the positional marker molecule will provide operational information about the experiment, such as reference coordinates and image capture data calibration. The image 120 is processed by a camera driver 122 which provides a processed image 124 and/or other information regarding the image 120 to other parts of the image processor 110. For example, the camera driver 122 may provide a processed image 125 that isolates a marker in the subject matter being studied, such as an image 125 that isolates a biological marker in a cell being studied. The process called registration 126 identifies features present or designed into the microchannel, such as edges and sharp corners, and determines their location relative to the image boundaries. This process 126 provides an image origin and coordinate frame relative to which data are extracted. The registration process 126 is important to mitigate the effects of drift of the microscope fixtures over the course of long experiments. Observation of points of the inlet channel at each image sample provides a positive control for image intensity; and equivalent points in the other inlet channel can provide a negative control, collectively 128. The origin and coordinate frame determines locations in the samples for measurements of the positive and negative controls. The origin and coordinate frame also specify the location and orientation the portion of the image used for data reduction in the next step 130. A “cropping filter” 132 prepared prior to the start of the experiment will crop and possibly rotate the image data for processing.

The image data emerging from the cropping filter 132 will be characterized before data reduction begins, thus simplifying the task of image interpretation. The computational results of well-established numerical transformations, including intensity mapping, edge detection, and centroid estimation, can be obtained with the present invention. This information, in time series, will serve as the “output” of our cellular “black box”. More elaborate algorithms, such as two-dimensional fast Fourier analysis, may also be employed.

Extracting data from images of cells is important for obtaining an output signal for system identification and for providing a feedback signal for closed loop control. The present invention may be used, for example, to concentrate on intensity mapping, and to study the change in the cell output in terms of chemotaxis, (cell movement in response to chemical gradients). The present invention can be used to assess cell motility through the use of green fluorescent protein linked to monomeric actin.

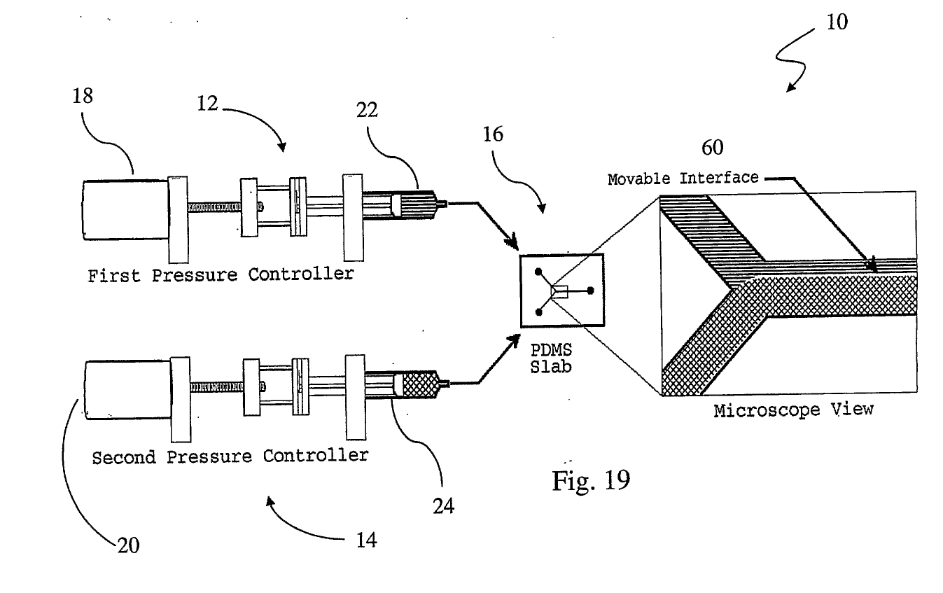

FIG. 19 is a schematic illustrating another embodiment of the fluid control apparatus 10 according to the present invention. That embodiment illustrates pressure controllers 12, 14 with screw-type mechanisms connecting the actuators 18, 20 to the fluid reservoirs 22, 24. That embodiment also illustrates a close-up view of the microfluidic device 16 and the fluid interface therein. Although feedback mechanisms, such as pressure sensors 26, 28, processors 30, 32, an image processor 100, and a supervision processor 104 are not illustrated, they may be used with this embodiment.

Many variations and uses are possible with the present invention. In one experiment a 10-mL plastic disposable syringe containing water was fed into one input of the microfluidic device through a 30-cm length of Teflon hose. Into the other input ran a solution of Cascade Blue Dextran (Molecular Probes), which has a molecular weight of roughly 10 kDa, at a concentration of 3 mg/ml, held at a fixed pressure by applying a fixed force to the plunger of the syringe. The fluid interface was adjusted by changing the pressure of the regulated fluid source while the pressure of the unregulated source remained roughly constant. The resolution of the sensor was approximately 125 Pa (0.018 PSI).

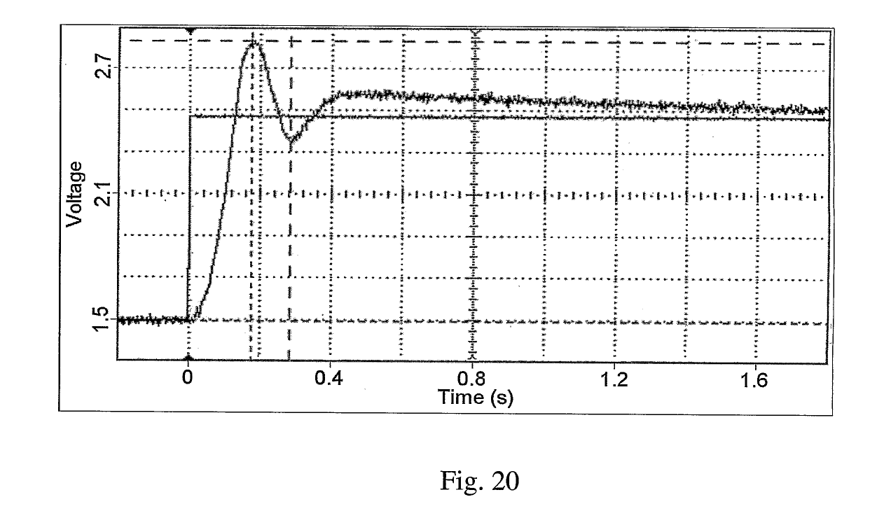

FIG. 20 is a graph illustrating the output of the pressure sensor from one embodiment of the present invention. The output is in volts in response to a 20.6 kPa (i.e., 1 Volt) change in the reference pressure. The particular response will vary depending on the particular embodiment of the invention, the components used, and other factors.

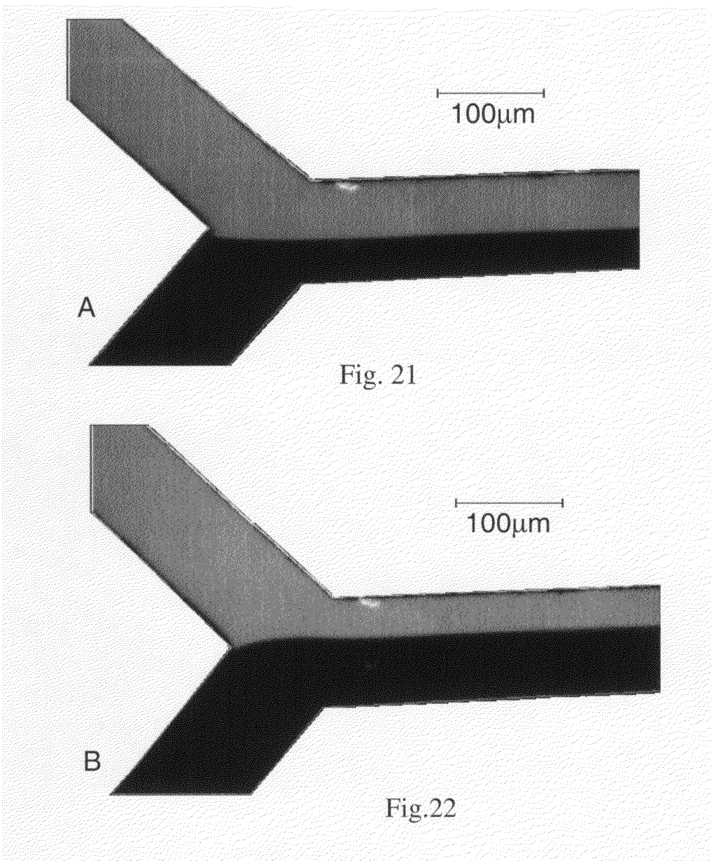

FIGS. 21 and 22 show the effects of adjusting the reference pressure of one reservoir, and thus the pressure difference between the two inputs. FIGS. 21 and 22 show a fluorescence photograph of the channel flow, with the edges of the channel enhanced for clarity. The movement of the interface is obvious. The interface is very straight, and there is no turbulent or diffusive mixing of the two streams that is visible to the naked eye.

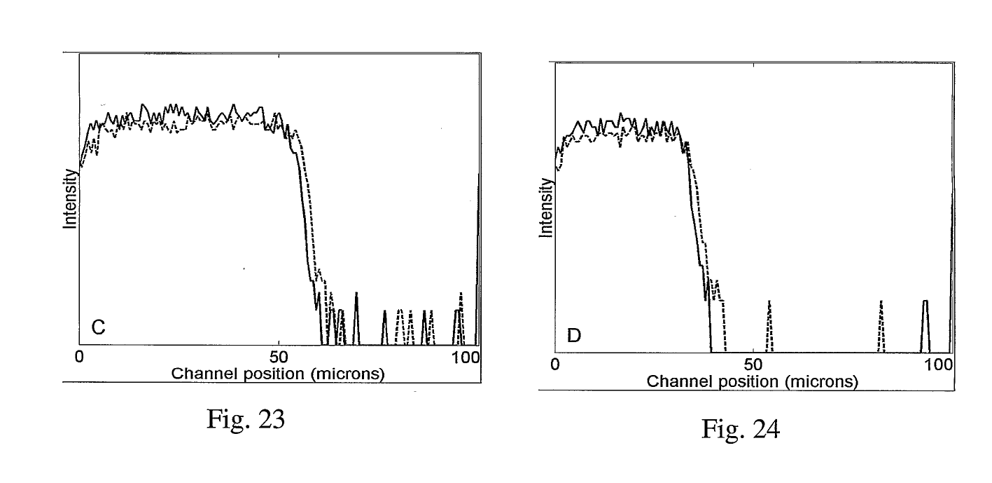

FIGS. 23 and 24 show plots of fluorescence intensity at two points along the main channel in a plane normal to the direction of flow. These plots provide a more quantitative measure of the location and sharpness of the step gradient. The intensity plots show an overlay of the flow patterns at 10 microns and at 250 microns downstream of the point of confluence. The abrupt change in the intensity in the cross track direction indicates the location of the interface. The plots demonstrate the movement of the interface as reservoir pressure changed. The plots also show that the effects of diffusion are minimal over a reasonable distance that is of experimental interest. The average pressure of the two reservoirs was approximately 17.2 kPa (2.50 PSI) gage. In FIG. 23 the pressure difference between the two reservoirs was approximately 1 kPa (0.15 PSI). Changing the reference pressure to the regulated reservoir caused the pressure difference to increase to approximately 6 kPa (0.87 PSI) resulting in the image of FIG. 24. The interface between the two flows moved 22 microns, or roughly one-quarter of the width of the channel.

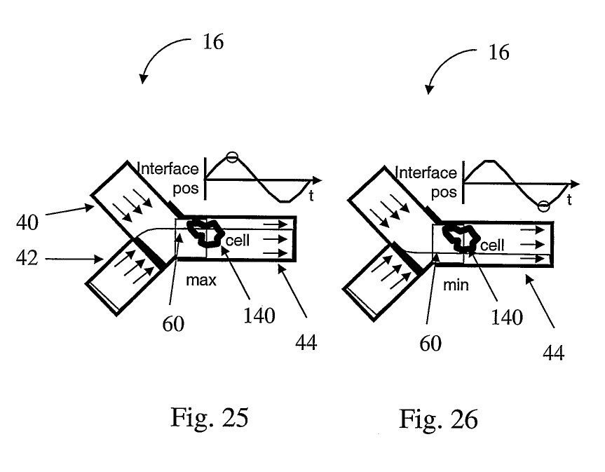

FIGS. 25 and 26 illustrate a microfluidic device 16 as it may be used with the present invention. In that example, a cell 140 is exposed to different fluids, and the distribution of the fluids across the cell 140 is varied by varying the pressure of the input fluids, thereby varying the fluid interface. For example, one fluid may contain a nutrient while the other fluid does not. The location of the interface 60 between the two fluids may be sinusoidally modulated so that at its maximum the nutrified channel covers a specified fraction of the cell 140, and at its minimum none of the nutrified fluid covers the cell 140. Images of the fluid interface 60, the cell 140, and changes to or reactions by the cell may be captured and monitored over time by the image processor 100 (not shown). These data may be used, for example, to determine the frequency response of the cell 140. In another embodiment using a three input microfluidic device 16, opposite ends of the same cell 140 may be exposed to the nutrified fluid, while the area in between is not. The cell 140 may be a biological cell or it may be non-biological, such as a mechanical device of other object which is being manufactured, processed, or studied.

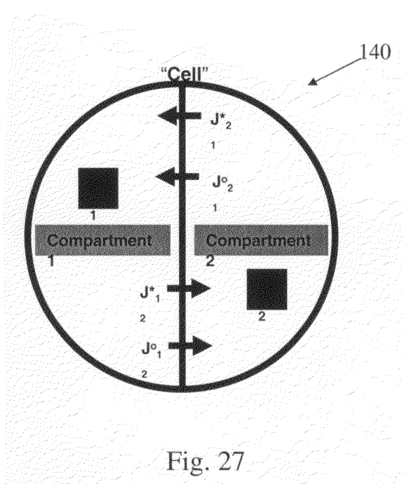

FIG. 27 illustrates one embodiment of a “cell” 140 that may be located within a microfluidic device 16 according to the present invention. The cell 140 in the illustrated embodiment is a two-compartment system and it may be used, for example, to analyze the diffusion properties.

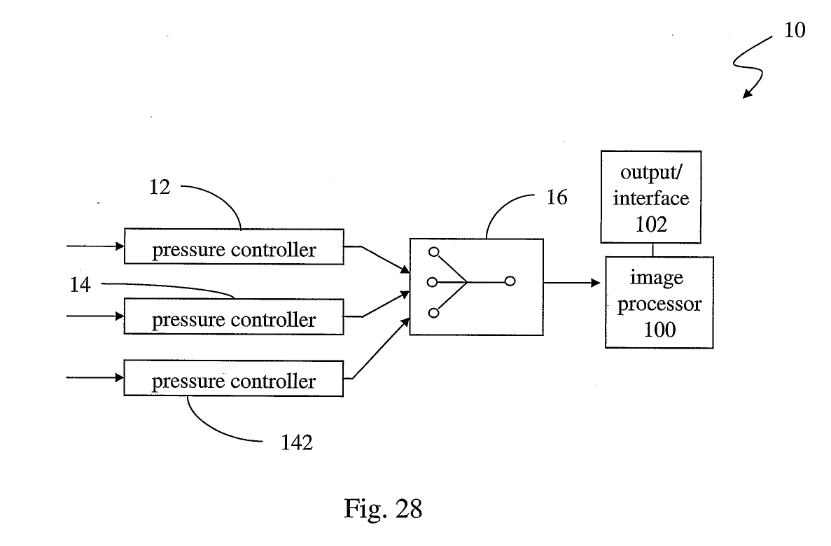

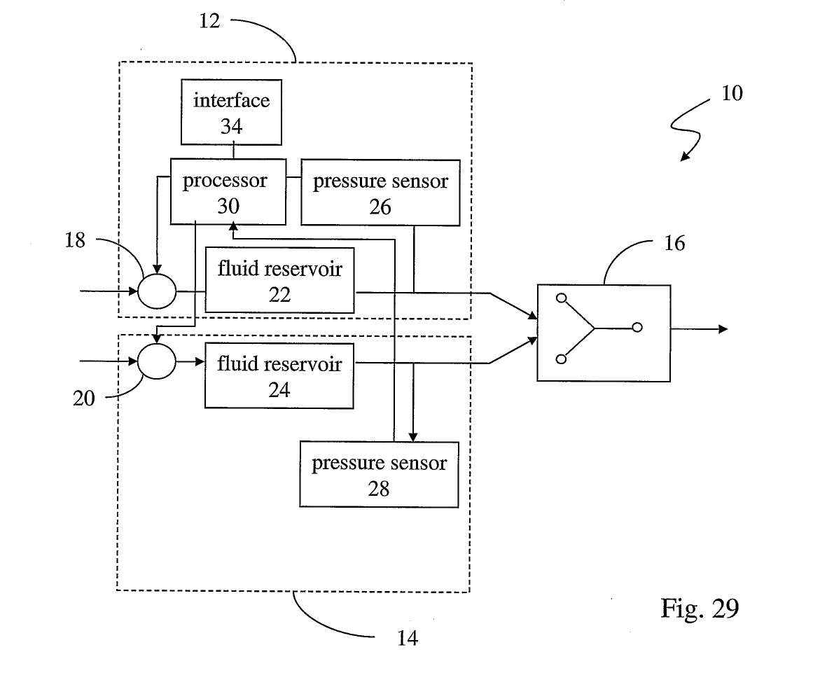

FIGS. 28 and 29 illustrate other embodiments of the present invention. FIG. 28 illustrates an apparatus 10 including more than two pressure controllers 12, 14, 142. Each of the pressure controllers 12, 14, 142 may, for example, include a fluid reservoir, an actuator, and other parts and components. FIG. 29 illustrates an apparatus 10 in which one processor 30 receives information from more than one pressure sensor 26, 28 and sends control signals to more than one actuator 18, 20. Other variations of the present invention are also possible.

Although the present invention has generally been described in terms of controlling the chemical environment of a cell, the present invention is applicable to other methods, apparatuses, systems, and technologies. For example, the present invention is also applicable to the manufacture and operation of microdevices or Microsystems such as micro-electromechanical systems, semiconductor fabrication, molecular self-assembly, and other technologies and applications. In addition, the examples provided herein are illustrative and not limiting, and other variations and modifications of the present invention are contemplated. For example, the present invention may be used with methods, apparatuses, and devices having channels with dimensions other than those specifically recited herein, having more than two input channels, having more than one output channel, having different flow rates, and other variations. Those and other variations and modifications of the present invention are possible and contemplated, and it is intended that the foregoing specification and the following claims cover such modifications and variations.

1. (canceled)

2. The apparatus of claim 28, wherein the microfluidic device includes more than two inputs.

3. The apparatus of claim 28, wherein the microfluidic device includes more than one output.

4. (canceled)

5. The apparatus of claim 2 including more than two fluid reservoirs.

6. The apparatus of claim 36, further comprising a processor having an input connected to the first pressure sensor and having an output connected to the first actuator.

7. The apparatus of claim 6, wherein the processor also has an input connected to the second pressure sensor and also has an output connected to the second actuator.

8. The apparatus of claim 6, further comprising a second processor having an input connected to the second pressure sensor and having an output connected to the second actuator.

9. (canceled)

10. (canceled)

11. The apparatus of claim 36, wherein the supervision processor is connected to the first and second actuators via at least one processor connected between at least one of the first and second pressure sensors and at least one of the first and second actuators.

12. The apparatus of claim 28, wherein the microfluidic device includes:
an output channel connected to the output;
a first input channel connected to the first input, wherein the first input channel is series-connected with the output channel;
a second input channel connected to the second input, wherein the second input channel is series-connected with the output channel.

13. The apparatus of claim 12, wherein the first and second input channels and the output channel each have a length, and wherein the length of the first input channel is approximately equal to the length of the output channel.

14. The apparatus of claim 12, wherein the first and second input channels and the output channel each have a length, and wherein the length of the first input channel is greater than the length of the output channel.

15. The apparatus of claim 12, wherein the first and second input channels each have a length, and wherein the length of the first input channel is approximately the same as the length of the second input channel.

16. (canceled)

17. (canceled)

18. (canceled)

19. (canceled)

20. The method of claim 38, further comprising identifying a characteristic of an object within the microfluidic device.

21. (canceled)

22. (canceled)

23. (canceled)

24. The method of claim 41, further comprising determining a location of the feature identified in the microfluidic device.

25. The method of claim 38, wherein:
controlling pressure in a first fluid reservoir includes:
sensing fluid pressure from the first fluid reservoir;
adjusting a first actuator in response to the fluid pressure in the first fluid reservoir; and
controlling pressure in a second fluid reservoir includes:
sensing fluid pressure from the second fluid reservoir;
adjusting a second actuator in response to the fluid pressure in the second fluid reservoir.

26. The method of claim 25, further comprising adjusting at least one of the first and second actuators to control the interface between adjacent fluid streams in the channel in the microfluidic device in response to the location of the interface between adjacent fluid streams in the channel in the microfluidic device.

27. The method of claim 38, wherein adjusting includes changing the location of the interface.

28. An apparatus comprising:
a first pressure controller;
a second pressure controller;
a microfluidic device including a first input connected to an output of the first pressure controller, a second input connected to an output of the second pressure controller, and an output;
an image processor providing information indicative of a location of an interface between adjacent fluid streams in a channel in the microfluidic device; and
a supervision processor having an input connected to an output of the image processor and having an output connected to at least one of the first and second pressure controllers.

29. The apparatus of claim 28, wherein the image processor includes a camera.

30. The apparatus of claim 28, wherein the image processor includes an electrochemical sensor.

31. The apparatus of claim 28, wherein the image processor includes an electrophysiological sensor.

32. The apparatus of claim 28, wherein the image processor includes a microscope.

33. The apparatus of claim 29, where the image processor includes a filter connected to an input of the camera.

34. The apparatus of claim 29, wherein the image processor includes a computer vision system connected to an output of the camera.

35. The apparatus of claim 34, wherein the computer vision system detects the interface between adjacent fluid streams in the channel in the microfluidic device.

36. The apparatus of claim 28, wherein
the first pressure controller includes:
a first fluid reservoir having an output;
a first pressure sensor connected to the output of the first fluid reservoir;
a first actuator connected to the first fluid reservoir;
a feedback loop connected between the first pressure sensor and the first actuator; and
the second pressure controller includes:
a second fluid reservoir having an output;
a second pressure sensor connected to the output of the second fluid reservoir;
a second actuator connected to the second fluid reservoir;
a feedback loop connected between the second pressure sensor and the second actuator.

37. The apparatus of claim 28, wherein the supervision processor provides control signals to the first and second pressure controllers to adjust the location of the interface.

38. A method for controlling fluid in a microfluidic device, comprising:
controlling pressure in a first fluid reservoir connected to a first input of the microfluidic device;
controlling pressure in a second fluid reservoir connected to a second input of the microfluidic device;
tracking a location of an interface between adjacent fluid streams in a channel in the microfluidic device; and
adjusting at least one of the pressure in the first fluid reservoir and pressure in the second fluid reservoir in response to tracking the interface.

39. The method of claim 38, further comprising:
identifying a condition within the microfluidic device; and
adjusting at least one of the pressure in the first fluid reservoir and pressure in the second fluid reservoir in response to the condition within the microfluidic device.

40. The method of claim 20, further comprising:
adjusting at least one of the pressure in the first fluid reservoir and pressure in the second fluid reservoir in response to a characteristic of an object within the microfluidic device.

41. The method of claim 40, further comprising:
imaging a portion of the microfluidic device;
identifying a feature in the microfluidic device; and
cropping an image of a portion of the microfluidic device.
